(19) United States
(12) Patent Application Publication
(10) Pub. No.: US 2012/0004437 A1
(43) Pub. Date: Jan. 5, 2012

(54) METHOD FOR PRODUCING (METH)ACRYLOSILANES

(75) Inventors: Volker Stanjek, Ampfing (DE); Wolfgang Ziche, Burghausen (DE)

(73) Assignee: WACKER CHEMIE AG, Muenchen (DE)

(21) Appl. No.: 13/060,571

(22) PCT Filed: Sep. 28, 2009
(86) PCT No.: PCT/EP2009/062517

§ 371 Date: Feb. 24, 2011

(30) Foreign Application Priority Data
Oct. 8, 2008 (DE) 10 2008 042 679.2

(51) Int. Cl. C07F 7/08

(52) U.S. Cl. 556/440

(57) ABSTRACT

The invention relates to a method for producing silanes (S) of the general formula (1); (R¹)₂C═C(R¹)C(O)O—(R²)—Si(R³)z(OR⁴)3-z, starting from a alkyl halide silane (S1) of the general formula (2); X-(R²)-Si(R³)z(OR⁴)3-z, and a salt (S2) of an unsaturated organic carboxylic acid of the general formula (3); M^{w+}[(R^{1′})₂C═C(R¹)C(O)O⁻]_{w}, where R¹, R^{1′}, R², R³, R⁴, X, M^{w+}, w and z have the meanings given in claim 1, wherein one or more components (L) having a boiling point below the boiling point of the alkyl halide silane (S1) are at least partially removed from the reaction mixture, partial mixture or individual reactant components by distillation before or during the reaction of components (S1) and (S2).

The present invention relates to a process for preparing acrylo- and methacrylosilanes with high reaction rates and space-time yields.

Acrylo- and methacrylosilanes find widespread application as adhesion promoters between inorganic and organic materials, as for example in sizes for glass fibers or in the production of artificial marble, as crosslinkers in organic polymers, such as in paints, for example, or else for treating fillers.

There are various processes known for preparing such compounds. Thus, for example, in DE 2851456 or DE 3832621, noble metal-catalyzed hydrosilylations are described in which Si—H-containing compounds are addition-reacted with allyl (meth)acrylates. A disadvantage of these processes, however, is the fact that either, in some cases, highly toxic alkoxysilanes such as trimethoxysilane, for example, must be used, or that, if the corresponding chlorosilanes, such as trichlorosilane, for example, are used, an additional alcoholysis step is necessary. The latter is extremely undesirable on account in particular of the associated additional temperature load on the (meth)acrylosilanes, which have a tendency toward polymerizations. With this synthesis route, moreover, it is possible to prepare only (meth)acrylosilanes whose spacer between the silyl group and the (meth)acrylic group possesses at least 3 carbon atoms. The α-(meth)acryloyloxymethyl-alkoxysilanes, which are of particular interest on account of their high reactivity in hydrolysis, are not obtainable by this path.

Therefore, preparing processes which are more favorable and also more common are those in which the (meth)acrylosilanes are prepared by a reaction of chloroalkylsilanes with alkali metal (meth)acrylates.

To accelerate the heterogeneous reaction, the reaction mixture is often admixed with a phase transfer catalyst. Processes of this kind are described in, for example, EP 0437653, EP 1249454 or WO 2007/063011.

However, the reaction rate of such heterogeneous reactions, even when a phase transfer catalyst is added, is often only moderate. In other words, reaction times of several hours, and high reaction temperatures of typically 70-120° C., are needed in order to achieve a largely complete conversion.

This is problematic insofar as the reaction products are sensitive to polymerization, particularly with regard to a free-radical polymerization. Because the polymerization of (meth)acrylates is highly exothermic and its rate increases sharply with increasing temperature, the danger of a “runaway” polymerization is a safety risk that must be taken extremely seriously. Moreover, the polymerization even of only small fractions of product leads to losses in yield and may—possibly only on distillative purification, where the resultant polymers accumulate in the distillation bottom product—lead to polymeric deposits which are difficult to remove and may sensitively disrupt a production operation.

It is true that the free-radical polymerization can be suppressed through the addition of free-radical scavengers, of the kind described in numerous patents, such as in EP 0 520 477, for example. The effectiveness of such measures, however, is limited in terms of time, since the free-radical scavenger is consumed when it develops its effect.

At the same time, there is an aim to limit to a minimum the amounts of free-radical scavengers used. The reason for this is not only the high price of these materials, but also, in particular, the fact that even the free-radical scavengers, and their degradation products, ultimately represent impurities, and as such may also develop unwanted properties. For instance, many stabilizers, and also the free-radical scavengers described in EP 0 520 477, lead to instances of discoloration, for example. Ultimately, they influence the polymerization behavior even, of course, when the (meth)acrylosilanes are ultimately to be specifically polymerized or copolymerized. This influencing, which may also affect the properties of the polymeric end product—for example, average chain lengths or chain-length distributions—is generally unwanted.

There is therefore a preference for synthesis processes where the reaction proceeds in as short a time as possible at temperatures that are as low as possible. This is true all the more so since the (meth)acrylo-silanes are subject to a thermal load not only during their synthesis but also during purification, which is usually distillative. The overall load ought therefore to be confined to the absolutely unavoidable minimum.

An object of the present invention, therefore, was to improve the existing processes for preparing acrylo-silanes or methacrylosilanes, allowing the corresponding products to be prepared at a consistent quality but at lower temperatures and/or in shorter reaction times.

The invention provides a process for preparing silanes (S) of the general formula (1)

(R^{1′})₂C═C(R¹)C(O)O—(R²) —Si (R³)_{z} (OR⁴)_{3-z} (1)

starting from a haloalkylsilane (S1) of the general formula (2)

X-(R²) -Si (R³)_{z} (OR⁴)_{3-z} (2),

and from a salt (S2) of an unsaturated organic carboxylic acid of the general formula (3)

M^{w+}[(R^{1′})₂C═C(R¹)C(O)O⁻]_{w} (3),

where

R¹ and R^{1′} independently of one another are each a hydrogen atom or a linear or branched hydrocarbon radical having 1-10 carbon atoms,

R² is a linear or branched hydrocarbon radical having 1-40 carbon atoms, which may comprise one or more heteroatoms selected from the elements nitrogen, oxygen, sulfur or phosphorus,

R³ and R⁴ independently of one another are linear or branched hydrocarbon radicals having 1-10 carbon atoms,

X is a halogen atom, and

M^{w+}is an alkali or alkaline earth metal ion, and

w, corresponding to the valence of M^{w+}, may adopt the values 1 or 2, and

z may adopt the values 0, 1 or 2,

wherein, before or during the reaction of components (S1) and (S2), one or more components (L) having a boiling point which is below the boiling point of the haloalkylsilane (S1) is or are removed at least partly by distillation from the reaction mixture, partial mixture or individual reactant components.

The invention is based on the surprising finding that the rate of reaction of components (S1) and (S2) can be accelerated significantly through the distillative removal of the low boilers (L) from the reaction mixture. This leads to higher space-time yields.

In the general formulae (1) to (3), R¹ and R^{1′} are preferably hydrogen or alkyl radicals having 1-3 carbon atoms, more particularly CH₃; R² is preferably an alkyl radical having 1-6 carbon atoms, more particularly CH₂ or (CH₂)₃ groups; R³ is preferably CH₃ or ethyl radicals; and R⁴ is preferably methyl, ethyl, propyl or isopropyl radicals, with methyl and ethyl radicals being particularly preferred. X is preferably chlorine or bromine, more preferably chlorine. M^{w+} is preferably an alkali metal ion selected from the ions of Li, Na, K, Rb, and Cs, with sodium ions and especially potassium ions being particularly preferred.

With particular preference the process of the invention is used for preparing silanes (S) which possess methacryloyloxy or acryloyloxy functions.

The components (L) which are removed distillatively from the reaction mixture before or during the reaction of components (S1) and (S2), and which have a boiling point which is below the boiling point of the haloalkylsilane (S1), are preferably alcohols, water and/or traces of (meth)acrylic acid. Particular preference is given here to alcohols, more particularly alcohols (A) of the general formula (4)

R⁴OH (4),

where R⁴ has the same definition as described for the general formulae (2) and (3). The alcohol (A) of the general formula (4) may enter the reaction mixture as an impurity both in the silane (S1) and in the salt (S2). It may also be formed by a transesterification in which a group OR⁴ on the silane function of the silanes (S) or (S1) is substituted by other protic impurities present in the salt (S2) (e.g., water, (meth)acrylic acid or other alcohols).

Since the (meth)acrylic salts (S2) usually contain small amounts of protic impurities, more particularly (meth)acrylic acid, water and/or alcohols, the above-mentioned substitution reactions on the silyl groups of the silanes (S) or (S1) mean that, in a reaction regime as described in the prior art, there are generally certain amounts of the alcohol (A) present in the reaction mixture, the level of which can be reduced through the inventive removal of the low boilers (L), this, surprisingly, resulting in the inventive effect already mentioned.

In the reaction of components (S1) and (S2) there are preferably also one or more phase transfer catalysts (P) and also one or more stabilizers (St) present. Examples of phase transfer catalysts (P) are the compounds described in EP 0437653, EP 1249454 or WO 2007/063011, more particularly tetraorganoammonium salts or tetraorganophosphonium salts, e.g., tetra-butylphosphonium chloride or bromide, butyltributyl-phosphonium chloride or bromide, methyltributyl-phosphonium chloride or bromide, and methyltriphenyl-phosphonium chloride. Tertiary phosphines of the general formula (5), as well, may be used as phase transfer catalysts (P)

R⁵₃P,

where R⁵ may be identical or different at each occurrence and is a monovalent, optionally substituted hydrocarbon radical having 1-20 carbon atoms, which may be interrupted by oxygen atoms and/or nitrogen atoms. Preferred phosphines are, for example, tributyl-phosphine, trioctylphosphine or triphenylphosphine. The phase transfer catalysts (P) are used preferably in amounts of 0.1-20% by weight, more preferably in amounts of 1-10% by weight, based in each case on the amount of the silane (S1) used.

Examples of stabilizers (St) are commercial compounds of the kind described in EP 0 520 477, for example. They may be aromatic amines, quinones, hydroquinones, sterically hindered phenols or stable free radicals such as phenothiazine, hydroquinone, hydroquinone monomethyl ether, N,N′-diphenyl-p-phenylenediamine, 2,6-di-tert-butylphenol, 2,6-di-tert-butyl-4-methyl-phenol, 2,t-di-tert-butyl-4(N,N-dimethylamino)methyl-phenol, 2,2,6,6-tetramethylpiperidyl N-oxide or 3,5-di-tert-butyl-4-hydroxytoluene. The stabilizers (St) are used preferably in amounts of 0.01-1% by weight, more preferably in amounts of 0.05-0.4% by weight, based in each case on the amount of the silane (S1) used.

Oxygen may serve as a costabilizer. For this reason, the reaction of the invention may be carried out in lean air—that is, oxygen containing 0.1-2% oxygen.

The phase transfer catalysts (P) and also the stabilizers (St) may optionally also be added as a solution in one or more solvents (L1). As solvents (L1) it is possible to use all solvents, preference being given to using common volatile solvents, examples being ketones such as acetone, methyl ethyl ketone, and methyl isobutyl ketone, esters such as ethyl acetate, alcohols such as methanol, ethanol, propanol, and butanol, ethers such as THF, dioxane, diethyl ether, and methyl tert-butyl ether, aromatics such as toluene and xylene, or alkanes such as pentane, hexane, cyclo-hexane and heptane.

In the process of the invention the solvents (L1) are preferably removed together with the volatile components (L).

In one preferred embodiment of the process of the invention for preparing silanes (S) of the general formula (1), this process features the following steps:

initially introducing a haloalkylsilane (S1) of the general formula (2),

at least partly distillatively removing one or more components (L) having a boiling point which is below the boiling point of the haloalkylsilane (Si),

adding a salt (S2) of an unsaturated organic carboxylic acid of the general formula (3).

These process steps are preferably carried out in the order indicated.

In a further process step, one or more phase transfer catalysts (P) and/or one or more stabilizers (St), or else a solution of one or more of these components in a solvent (L1), are or is preferably added as well. This addition may be made before, during or after the initial introduction of the silane (S1). It is also possible to premix the components (P), (St) and/or (L1) with the halosilane (S1) and introduce them together.

With particular preference a solution of one or more phase transfer catalysts (P) and also, optionally, one or more stabilizers (St) in a solvent (L1) is added before the (partial) removal of the more volatile component or components (L), and so in this process step the solvent or solvents (L1) is or are likewise removed wholly or at least partly.

Moreover, the reaction mixture may also comprise one or more solvents. Preferably, however, the reaction is carried out without solvent.

In the course of the procedure of the process of the invention, the low boilers (L) are preferably removed by lowering the pressure, after having introduced some or all of the reaction components into the reaction vessel, to an extent such that the corresponding mixture boils. Then preferably 0.1-5% by weight of the overall reaction mixture are removed distillatively.

In one preferred process, the low boilers are removed from a mixture which already comprises the silane of the general formula (1) and optionally also already comprises phase transfer catalysts (P) and/or stabilizers (St), but not yet the salt (S2). In another preferred variant, the low boilers (L) are removed after the (meth)acrylate salt (S2) as well has been wholly or partly added. With particular preference there is a distillation step for removing the low boiler or low boilers (L) carried out before or at the beginning of the reaction, and one or more additional distillation steps are also carried out during the reaction. The latter is especially sensible when during the reaction, as a result of the above-described substitutions on the silyl groups of the silanes (S) and/or (S1), small amounts of the alcohol (A) are formed afresh, as a result, for example, of the release of traces of water from the salt (S2) as it dissolves, and a resultant hydrolysis reaction of the silanes (S) or (S1). These traces of alcohol are then removed by the additional distillation steps.

The amount of free alcohol (A) of the formula (4) during the reaction of components (S1) and (S2) is preferably below 4% by weight, more particularly below 2% by weight, based in each case on the overall reaction mixture, with values below 1.5% or below 1% by weight being particularly preferred.

In the case of one preferred embodiment, the distillative removal of the low boilers (L) is carried out at reaction temperature and/or during the warm-up phase and is controlled solely by the pressure and/or the reflux ratio in the condenser. This has the advantage that there are no losses of time caused by long warm-up and cool-down phases.

The temperature during the distillative removal of the volatile components (L) and/or during the reaction of the haloalkylsilane (S1) of the general formula (2) with the salt (S2) of an unsaturated organic carboxylic acid of the general formula (3) is preferably at least 60° C., more preferably at least 70° C., and preferably not more than 150° C., more preferably not more than 120° C. The halogen salts formed as a byproduct, and also, if appropriate, any residues of the (meth)acrylic salts with anions of the general formula (4), are separated off preferably by filtration. Subsequently the product is purified, preferably distillatively, in which case one or more purification steps are performed. It is preferred first to separate off low-boiling impurities by distillation. This is done preferably under reduced pressure and at temperatures of at least 20° C., more preferably at least 40° C., and preferably not more than 120° C., more preferably not more than 80° C.

Subsequently, if desired, the silane (S) of the general formula (1) itself is distilled, and this distillation step is also carried out preferably under reduced pressure, and so the liquid-phase temperature during the distillation is below 200° C., preferably below 150° C., and more preferably below 130° C.

Examples of unsaturated silicon compounds (S) of the general formula (1) are acrylosilanes, such as, for example, acryloyloxymethyltrimethoxysilane, acryloyloxymethyltriethoxysilane, acryloyloxymethyl-triphenyloxysilane, acryloyloxymethyltriisopropoxy-silane, acryloyloxymethyltris(2-methoxyethoxy)silane, acryloyloxymethyl(methyl)dimethoxysilane, acryloyloxy-methyl(methyl)diethoxysilane, acryloyloxymethyl-(methyl)diphenyloxysilane, acryloyloxymethyl(methyl)di-isopropoxysilane, acryloyloxymethyl(methyl)bis(2-methoxyethoxy)silane, acryloyloxymethyl(dimethyl)meth-oxysilane, acryloyloxymethyl(dimethyl)ethoxysilane, acryloyloxymethyl(dimethyl)phenyloxysilane, acryloyloxymethyl(dimethyl)isopropoxysilane, acryloyloxymethyl(dimethyl)(2-methoxyethoxy)silane, 3-acryloyloxypropyltrimethoxysilane, 3-acryloyloxypropyltriethoxysilane, 3-acryloyl-oxypropyltriphenyloxysilane, 3-acryloyloxypropyltri-isopropoxysilane, 3-acryloyloxypropyltris(2-methoxy-ethoxy)silane, 3-acryloyloxypropyl(methyl)dimethoxy-silane, 3-acryloyloxypropyl(methyl)diethoxysilane, 3-acryloyloxypropyl(methyl)diphenyloxysilane, 3-acryloyl-oxypropyl(methyl)diisopropoxysilane, 3-acryloyloxy-propyl(methyl)bis(2-methoxyethoxy)silane, 3-acryloyl-oxypropyl(dimethyl)methoxysilane, 3-acryloyloxypropyl-(dimethyl)ethoxysilane, 3-acryloyloxypropyl(dimethyl)-phenyloxysilane, 3-acryloyloxypropyl(dimethyl)iso-propoxysilane, 3-acryloyloxypropyl(dimethyl)(2-methoxy-ethoxy)silane or else methacrylosilanes such as, for example, methacryloyloxymethyltrimethoxysilane, meth-acryloyloxymethyltriethoxysilane, methacryloyloxy-methyltriphenyloxysilane, methacryloyloxymethyltri-isopropoxysilane, methacryloyloxymethyltris(2-methoxy-ethoxy)silane, methacryloyloxymethyl(methyl)dimethoxy-silane, methacryloyloxymethyl(methyl)diethoxysilane, methacryloyloxymethyl(methyl)diphenyloxysilane, meth-acryloyloxymethyl(methyl)diisopropoxysilane, methacryl-oyloxymethyl(methyl)bis(2-methoxyethoxy)silane, meth-acryloyloxymethyl(dimethyl)methoxysilane, methacryloyl-oxymethyl(dimethyl)ethoxysilane, methacryloyloxymethyl-(dimethyl) phenyloxysilane, methacryloyloxymethyl-(dimethyl) isopropoxysilane, methacryloyloxymethyl-(dimethyl)(2-methoxyethoxy)silane, 3-methacryloyloxy-propyltrimethoxysilane, 3-methacryloyloxypropyltri-ethoxysilane, 3-methacryloyloxypropyltriphenyloxy-silane, 3-methacryloyloxypropyltriisopropoxysilane, 3-methacryloyloxypropyltris(2-methoxyethoxy)silane, 3-methacryloyloxypropyl(methyl)dimethoxysilane, 3-methacryloyloxypropyl(methyl)diethoxysilane, 3-meth-acryloyloxypropyl(methyl)diphenyloxysilane, 3-meth-acryloyloxypropyl(methyl)diisopropoxysilane, 3-meth-acryloyloxypropyl(methyl)bis(2-methoxyethoxy)silane, 3-methacryloyloxypropyl(dimethyl)methoxysilane, 3-meth-acryloyloxypropyl(dimethyl)ethoxysilane, 3-methacryl-oyloxypropyl(dimethyl)phenyloxysilane, 3-methacryloyl-oxypropyl(dimethyl)isopropoxysilane, 3-methacryloyloxy-propyl(dimethyl)(2-methoxyethoxy)silane.

Examples of particularly preferred unsaturated organosilicon compounds (S) of the general formula (1) are those in which R² is a methylene group. These silanes are often notable for particularly high reactivity and, in association therewith, for a particularly high polymerization tendency. Particularly preferred are the following: acryloyloxymethyl-trimethoxysilane, acryloyloxymethyltriethoxysilane, acryloyloxymethyl(methyl)dimethoxysilane, acryloyloxy-methyl(methyl)diethoxysilane, acryloyloxymethyl-(dimethyl)methoxysilane, acryloyloxymethyl(dimethyl)-ethoxysilane, methacryloyloxymethyltrimethoxysilane, methacryloyloxymethyltriethoxysilane, methacryloyloxy-methyl(methyl)dimethoxysilane, methacryloyloxymethyl-(methyl)diethoxysilane, methacryloyloxymethyl-(dimethyl)methoxysilane and methacryloyloxymethyl-(dimethyl)ethoxysilane.

All of the above symbols in the above formulae have their definitions in each case independently of one another. In all formulae the silicon atom is tetra-valent.

In the inventive and comparative examples which follow, it is the case, unless indicated otherwise, that all quantity figures and percentage figures are given by weight, and all reactions are carried out under a pressure of 0.10 MPa (absolute) and at a temperature of 20° C.

Inventive Example 1:

A 500 ml flask with KPG stirrer, condenser and thermometer is initially charged with 319.12 g (1.50 mol) of chloromethyltriethoxysilane, and 8.85 g of tetrabutylphosphonium chloride and 0.15 g of phenothiazine are added. This charge is heated to 110° C. in an oil bath, and then 195.6 g (1.575 mol) of potassium methacrylate are added. At the end of the addition, the pressure in the reaction vessel is lowered to down to 100 mbar, and a total of around 15 g of low-boiling components are removed by distillation. Thereafter the pressure is raised again to atmospheric pressure. During the distillation, and also during the whole of the following reaction, the reaction temperature is held constant at between 108 and 112° C. After a total reaction time of 1 hour (including the distillation at the beginning of the reaction), the conversion to methacryloyloxymethyltriethoxysilane, determined by means of GC, is around 82 mol %. After 2 hours the conversion is around 92 mol %. After 4 hours the reaction is largely complete (i.e., the amount of unreacted chloromethyltriethoxysilane is less than 0.5 mol %). In all samples the ethanol content is between 1.2 and 1.5 mol %, with a slightly rising trend in the course of the reaction.

After the filtration of the potassium chloride formed, the product is distilled using a laboratory short-path evaporator. This gives the product in a yield of around 94%, in a purity of around 98.5%.

Inventive Example 2:

A 500 ml flask with KPG stirrer, condenser and thermometer is initially charged with 319.12 g (1.50 mol) of chloromethyltriethoxysilane, and 8.85 g of tetrabutylphosphonium chloride and 0.15 g of phenothiazine are added. This charge is heated to 110° C. in an oil bath, and then 195.6 g (1.575 mol) of potassium methacrylate are added. At the end of the addition, the pressure in the reaction vessel is lowered to down to 100 mbar, and a total of around 14 g of low-boiling components are removed by distillation. Thereafter the pressure is raised again to atmospheric pressure. During the distillation, and also during the whole of the following reaction, the reaction temperature is held constant at between 108 and 111° C. After a total reaction time of 1 hour (including the distillation at the beginning of the reaction), the conversion to methacryloyloxymethyltriethoxysilane, determined by means of GC, is around 83 mol %. Subsequently, as a result of a further reduction in pressure, a further approximately 6 g of distillate are taken off. After 2 hours, less than 0.2 mol % of reactant is present in the reaction mixture. The ethanol content of the 1st sample after 1 hour is 1.3 mol %; the ethanol content of the 2nd sample after 2 hours is 0.9 mol %.

Comparative Example 1:

The procedure of inventive example 1 is repeated, but without the distillation step following addition of the potassium methacrylate. After 1 hour, the conversion determined by means of GC is around 40 mol %. After 2 hours the conversion is around 59 mol %. After 4 hours as well, finally, a conversion of only around 81 mol % can be achieved. In all samples the ethanol content is relatively constant between 2.0 and 2.1 mol %.

Inventive Example 3:

A 500 ml flask with KPG stirrer, condenser and thermometer is initially charged with 231.98 g (1.50 mol) of chloromethylmethyldimethoxysilane, and 8.85 g of tetrabutylphosphonium chloride and 0.15 g of phenothiazine are added. This charge is heated to 90° C. in an oil bath, and then 195.6 g (1.575 mol) of potassium methacrylate are added. At the end of the addition, the pressure in the reaction vessel is lowered to around 700 mbar, and a total of around 7.8 g of low-boiling components are removed by distillation. Thereafter the pressure is raised again to atmospheric pressure. During the distillation, and also during the whole of the following reaction, the reaction temperature is held constant at between 88 and 90° C.

After a total reaction time of 1 hour (including the distillation at the beginning of the reaction), the conversion to methacryloyloxymethylmethyldi-methoxysilane, determined by means of GC, is around 93 mol %. Subsequently, as a result of a further reduction in pressure, a further approximately 4.1 g of distillate are taken off. After 2 hours the conversion is around 99 mol %, and after 3 hours there is less than 0.2 mol % of reactant in the reaction mixture. The methanol content of the 1st sample after 1 hour is 1.0 mol %; the methanol content of the 2nd and 3rd sample after 2 hours and after 3 hours is 0.8 mol %.

After the filtration of the potassium chloride formed, the product is distilled using a laboratory short-path evaporator. This gives the product in a yield of around 92%, in a purity of around 98.2%.

Comparative Example 2:

The procedure of inventive example 2 is repeated, but without the distillation steps after the addition of the potassium methacrylate and after a reaction time of 1 hour. After a reaction time of 1 hour, the conversion determined by means of GC is around 75 mol %. After 2 hours the conversion is around 85 mol %. After 3 hours, finally, a conversion of around 93 mol % is achieved. Only after 4 hours is the conversion, at around 97 mol %, of a satisfactory order of magnitude.

In all of the samples the methanol content is relatively constant at between 1.6 and 1.7 mol %.

1. A process for preparing silanes (S) of the general formula (1)
(R^{1′})₂C═C(R¹)C(O)O—(R²) —Si (R³)_{z} (OR⁴)_{3-z} (1)
starting from a haloalkylsilane (S1) of the general formula (2)
X-(R²) -Si (R³)_{z} (OR⁴)_{3-z} (2),
and from a salt (S2) of an unsaturated organic carboxylic acid of the general formula (3)
M^{w+}[(R^{1′})₂C═C(R¹)C(O)O⁻]_{w} (3),
where
R¹ and R^{1′} independently of one another are each a hydrogen atom or a linear or branched hydrocarbon radical having 1-10 carbon atoms,
R² is a linear or branched hydrocarbon radical having 1-40 carbon atoms, which optionally comprises at least one heteroatom selected from the group consisting of nitrogen, oxygen, sulfur and phosphorus,
R³ and R⁴ independently of one another are linear or branched hydrocarbon radicals having 1-10 carbon atoms,
X is a halogen atom, and
M^{w+} is an alkali or alkaline earth metal ion, and
w, corresponding to the valence of M^{w+}, may adopt the values 1 or 2, and
z may adopt the values 0, 1 or 2,
wherein, before or during the reaction of components (S1) and (S2), at least one component (L) having a boiling point which is below the boiling point of the haloalkylsilane (S1) is removed at least partly by distillation from the reaction mixture, partial mixture or individual reactant components.

2. The process as claimed in claim 1, wherein R¹ and R^{1′} are a hydrogen atom or alkyl radical having 1-3 carbon atoms.

3. The process as claimed in claim 1, wherein R³ is CH₃ or ethyl radicals.

4. The process as claimed in claim 1, wherein X is chlorine.

5. The process as claimed in claim 1, wherein the at least one component (L) comprises alcohols (A) of the general formula (4)
R⁴OH (4).

6. The process as claimed in claim 1, wherein at least one phase transfer catalyst (P) is present.

7. The process as claimed in claim 1, wherein a temperature during the distillative removal of the volatile components (L) is 60° C. to 150° C.

8. The process as claimed in claim 1, wherein a temperature during the reaction of the haloalkyl-silane (S1) of the general formula (2) with the salt (S2) of an unsaturated organic carboxylic acid of the general formula (3) is 60° C. to 150° C.

9. The process as claimed in claim 1, which comprises at least the following steps:
initially introducing a haloalkylsilane (S1) of the general formula (2),
at least partly distillatively removing one or more components (L) having a boiling point which is below the boiling point of the haloalkylsilane (S1), and
adding a salt (S2) of an unsaturated organic carboxylic acid of the general formula (3).

10. The process as claimed in claim 9, wherein a solution of at least one phase transfer catalyst (P) and also optionally at least one stabilizer (St) in at least one solvent (L1) is added before a complete or partial removal of the more volatile component or components (L), and so, in the last-stated process step, the at least one solvent (L1) is likewise removed wholly or at least partly.

11. The process as claimed in claim 1, wherein, during the reaction of the components (S1) and (S2), the amount of free alcohol (A) of the general formula (4)
R⁴OH (4),
is below 4% by weight, based on an overall reaction mixture weight.
